(19) United States
(12) Patent Application Publication
(10) Pub. No.: US 2003/0028513 A1
(43) Pub. Date: Feb. 6, 2003

(54) System and method for providing help services

(76) Inventor: Neal Pawar, Brooklyn, NY (US)

Correspondence Address: KENYON & KENYON, 1500 K STREET, N.W., SUITE 700, WASHINGTON, DC, 20005, US

(21) Appl. No.: 10/194,002

(22) Filed: Jul. 15, 2002

Related U.S. Application Data
(60) Provisional application No. 60/304,797, filed on Jul. 13, 2001.

(51) Int. Cl. G06F 7/00

(52) U.S. Cl. 707/1

(57) ABSTRACT

An intelligent application-independent help system and method that automatically captures and analyzes information specific to the context of the application in use and the error encountered. The system not only provides the user with solutions to errors encountered during use of the application, but also offers easy access to relevant suggestions and explanations on the features and the options within the application. The system includes an analyzer process that processes the information captured and links to an appropriate help document in a knowledge base. In the event that the analyzer process fails to locate a relevant solution in the knowledge base or if the user prefers to speak directly with live support, the analyzer routes the problem along with all captured contextual information on that problem to support personnel. This allows the support team to reduce the number of questions they need to ask the user, thus reducing the amount of time required to solve the problem.

### CROSS REFERENCE TO RELATED APPLICATION

This application claims the benefit under 35 U.S.C. § 119(e) of U.S. Provisional Application No. 60/304,797, filed Jul. 13, 2002, which is hereby incorporated by reference in its entirety.

### BACKGROUND OF THE INVENTION

Computer users are often left either confused by the innumerable options on their screens and dialog boxes, or frustrated by the unintelligible errors thrown up by applications. These errors often include obscure references to the underlying code and have no useful feedback to even an educated user. Traditionally, when users encounter such problems with applications, they have three options: (a) search the online help provided by the application (if available); (b) call the support personnel at the help desk; or (c) contact the vendor directly to get help on how to resolve the problem. The first option requires that users have a basic idea and context of what to search for, and how to use the knowledge base. Failing this, such searches invariably lead to lengthy search results with mostly irrelevant results. The latter two options require users to describe their errors (which they seldom understand) and/or questions in great detail—often to multiple support personnel. The support staff then uses this information to locate solutions in the knowledge base or provide help based on their expertise and experience.

While these methods may ultimately lead to resolution of user problems, they require users to have an understanding of the context of the problem encountered. As a result, such interactions are time-consuming and frustrating for users, and can result in declines in user productivity. Additionally, as the three options described above require human intervention, they are often expensive to the organization implementing them. On the organization's part, the support personnel are faced with frustrated users who are often ill-suited to provide technical information that is critical to the resolution of the problem.

Accordingly, there is a need in the art for a system and method to minimize user downtime and improve the performance of support personnel.

### SUMMARY OF THE INVENTION

The present invention is directed to an intelligent system and method that provides a software application user quick and timely problem resolution, by tracking and capturing information specific to the application, and the application and/or error event encountered by the user. A built-in analyzer process uses this information to locate a relevant help document in a knowledge base. In the absence of a relevant document, the analyzer ensures user problem resolution by routing this information to support personnel. This eliminates the need for the user to recount and explain the problem, and in turn provides the support personnel with critical information and technical overview that are important for an effective and rapid resolution of the problem.

Embodiments of the present invention also include the ability to integrate with any application without the need for changing the application source code. Intelligent routing of the problem for help on undocumented contexts, configuring, capturing and transmitting the context of the problem at hand may be incorporated into an application without the need for source code change. Further, embodiments of the present invention also provide the options of either restricting its function to alert boxes only, or allowing seamless incorporation into all dialog windows, without the need for source code change. A knowledge base map can be maintained with commonly encountered application-related questions and error-related problems mapped to solutions. The knowledge base map is regularly updated as new error events are encountered or new application events are introduced (e.g., through application upgrades). Once incorporated into an application, the invention provides easy access to these solutions from the application error or dialog box.

### BRIEF DESCRIPTION OF THE DRAWINGS

FIG. 1 is a block diagram that depicts a host in accordance with an embodiment of the present invention.

FIG. 2 is a block diagram that depicts a network architecture in accordance with an embodiment of the present invention.

FIG. 3 is a flow chart that illustrates a process for intercepting context information in accordance with an embodiment of the present invention.

FIG. 4 is a flow chart that illustrates a process for preparing context information in response to user's help request in accordance with an embodiment of the present invention.

FIG. 5 is a flow chart that illustrates a process for providing help services based on context information in accordance with an embodiment of the present invention.

### DETAILED DESCRIPTION

### Host Architecture

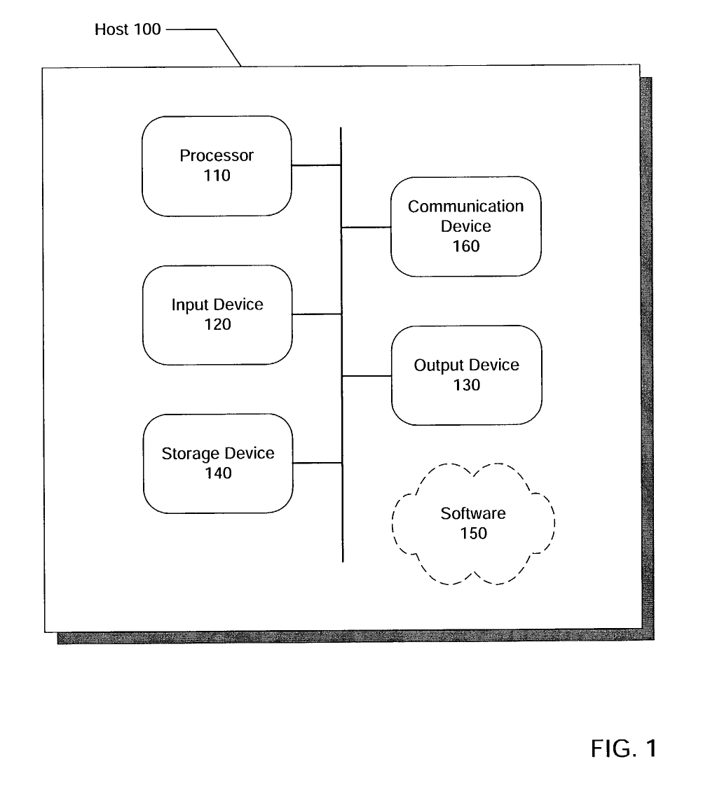

FIG. 1 is a block diagram depicting the internal structure of a host in accordance with an embodiment of the present invention. Host 100 may be a personal computer, handheld personal digital assistant (“PDA”), or any other type of processor-based device. Host 100 may include a processor 110, input device 120, output device 130, storage device 140, software 150, and communication device 160.

Input device 120 may include a keyboard, mouse, pen-operated touch screen, voice-recognition device, or any other device that provides input from a user. Output device 130 may include a monitor, printer, disk drive, speakers, or any other device that provides tangible output to user. Storage device 140 may include volatile and nonvolatile data storage. Volatile data storage includes RAM, a cache, or any storage medium that temporarily holds data while being processed; nonvolatile data storage includes a hard drive, CD-ROM drive, tape drive, removable storage disk, or any other non-temporary storage medium. Communication device 160 may include a modem, network interface card, or any other device capable of transmitting and receiving signals over a network.

Software 150 contains the logic used by the capture process and analyzer process of the present invention, as provided herein. Software 150 may take the form of custom-written programs and libraries that are either interpreted or compiled, and may be written in any programming language, such as C, C++, or JAVA.

One skilled in the art would appreciate that the components of host 100 may also be connected wirelessly, possibly through an infrared connection.

### Network Data Flow

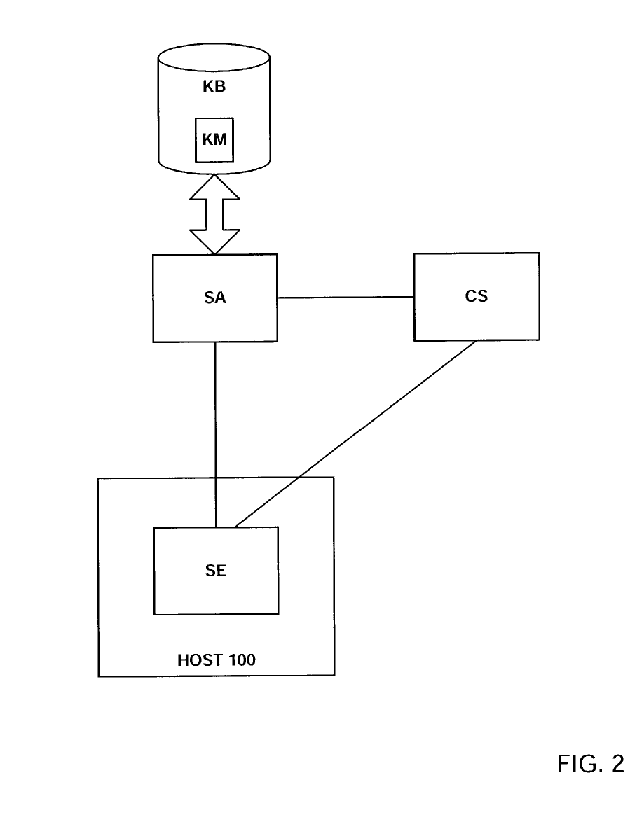

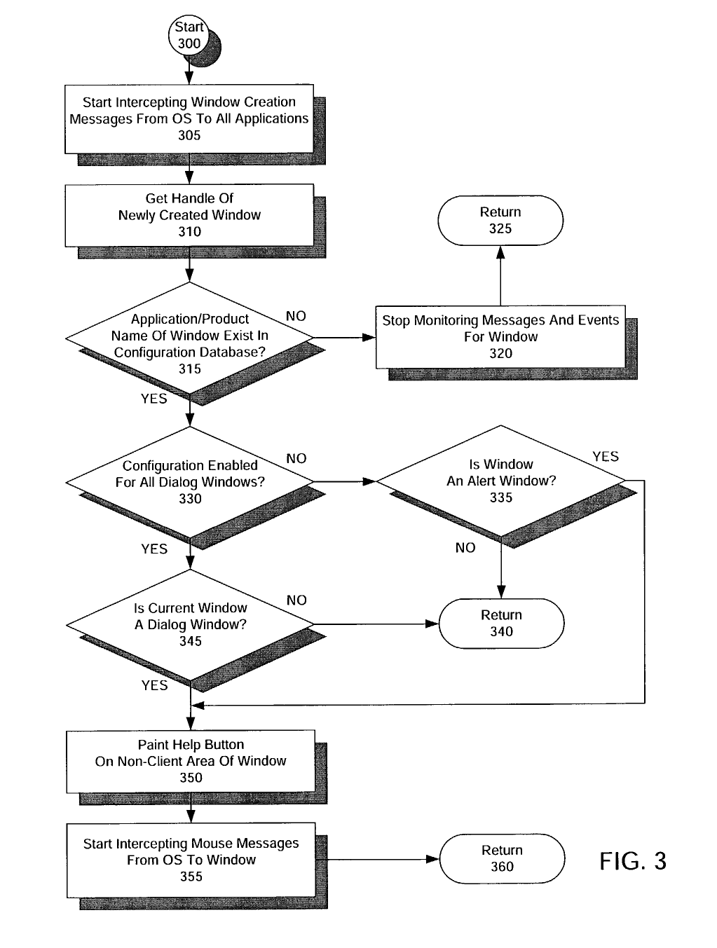

FIG. 2 is a block diagram that depicts a network architecture in accordance with an embodiment of the present invention, and FIGS. 3-5 depict data process and flow throughout this architecture. The following description illustrates an embodiment of the present invention in which host 100 operates under a Microsoft Windows operating system provided by Microsoft Corp. of Redmond, Wash.

Capture process SE runs on host 100 to capture context information about a user's computing environment, in the event a problem arises while the user is working in a software application. Once capture process SE retrieves the context information, it sends the information to analyzer process SA, which uses the information to locate related help documents in knowledge base KB, using knowledge base map KM. Knowledge base map KM maps context information to documents in knowledge base KB. If analyzer SA locates a relevant document, it displays the document to the user. If no related document can be located, analyzer process SA sends the context information to chat server CS, where a live analyst may use the information to resolve the user's problem in a real time through a chat session. This summary description is expressed in more detailed below through the discussion of FIGS. 3-5.

The present invention may utilize any network, network protocol and network connectivity as known in the art. Knowledge base map KM and knowledge base KB may comprise any storage-related medium and associated functionality, as commonly known in database management systems and expert systems. Capture process SE and analyzer process SA comprise software 150, and chat server CS comprises software employing the associated functionality as described herein, which may include features found in online chat services, instant messaging services, and/or live support services as known in the art. Chat server CS may be implemented by any application server computing device as known in the art, which includes elements similar to those of host 100.

The following is a more detailed explanation of an embodiment of the invention, with reference to FIGS. 3-5. Any application sends various messages to the operating system to create UI (“User Interface”) elements like windows, buttons etc. As shown in FIG. 3, capture process SE intercepts all messages and events related to windows generated by the operating system (step 305) by using hooks in the Windows environment. A hook is a mechanism known in the art by which a function (i.e., capture process SE) can intercept events like messages, mouse actions, keystrokes from the operating system before they reach an application.

Once Capture process SE intercepts a message about the creation of any window, it gets the handle of the newly created window (step 310), enabling capture process SE to extract information about that application like application name, product name, etc. (This may be implemented using Window Handle in the Microsoft Windows environment.) Capture process SE then checks the application name of the window being created against a list of supported application names in its configuration database (not shown) (step 315). (The configuration database may be implemented using the Windows registry.)

If the application is not listed in the supported application list, then capture process SE may extract the product name to which the window belongs and again check against a list of supported product names. If this product is not available in the supported product list, it will stop monitoring messages and events for the window (step 320), and return control to operating system for normal operation (steps 325). If the application name or the product name is available in the supported list (i.e., the window belongs to a supported application or product), capture process SE will proceed further.

Capture process SE checks if it has been configured to support all dialog windows (step 330) or only alert windows (step 335). If it has been configured to support only alert windows, it checks whether the window is an alert message box by analyzing the characteristics of that window. If capture process SE has been configured to support all dialog windows and the window is a dialog window (step 345), or if the window is an alert box, then capture process SE will start intercepting other messages pertaining to this window. (This may be implemented in Windows by installing the WH_GETMESSAGE hook and WH_CALLWNDPROCRET hook into the corresponding window thread).

Capture process SE then may paint a button on the title bar of the dialog box to enable the user to access additional help by clicking this new button (step 350). In another embodiment, the button may be designed to look and behave like a URL in a Web browser. In yet another embodiment, it is possible to implement this button by using a different mechanism such as a keyboard key combination. Capture process SE then starts intercepting mouse events on the window (step 355).

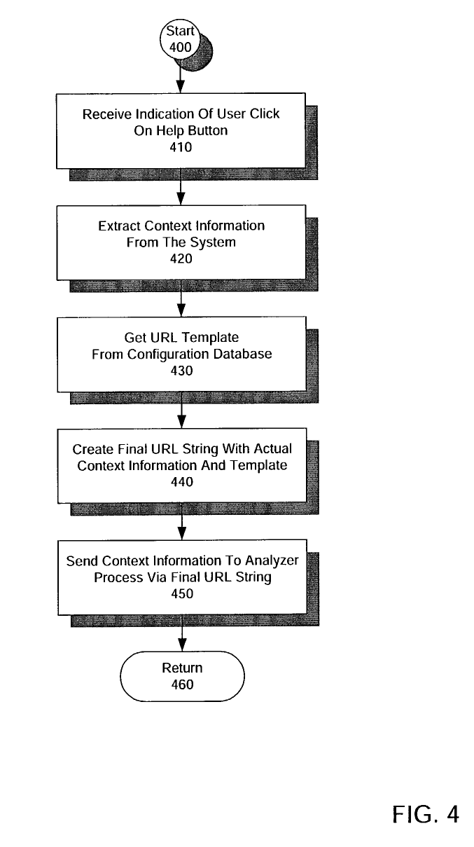

As shown in FIG. 4, when the user clicks the button created by capture process SE to get help relating to the current window (step 410), capture process SE detects this event and then extracts context information from the system (step 420). The context information extracted may include the following:

application name

window caption

messages, including an error message if present

product name

product version

file version

language

user name

computer name

domain of computer

IP address of computer

classID of the dialog box

number of objects on the dialog box

Those skilled in the art could easily modify this list, for example, to send additional information to analyzer process SA.

Capture process SE then retrieves a URL template from the configuration database (step 430). This URL may be configurable as per the analyzer process SA requirements (i.e., defining a subset of the context information listed above to be sent to analyzer process SA). Each context information item that can be accepted by analyzer process SA may be specified as a placeholder in the URL. Capture process SE may parse this URL and replace the placeholders with the actual context information it has extracted (step 440). Capture process SE then sends this modified URL to a web server, thereby invoking analyzer process SA (step 450).

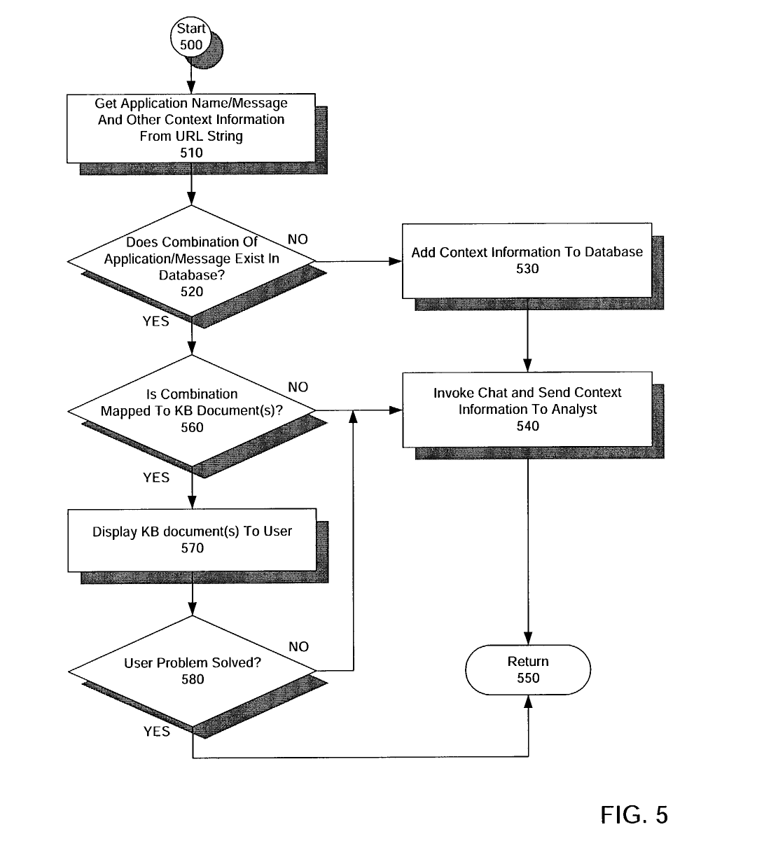

As shown in FIG. 5, analyzer process SA uses a database (knowledge base map KM) that maps the combination of application name, product name and message (which could be an error message) to a knowledge base document identifier. It provides facilities for interactive management of this mapping.

Analyzer process SA receives the context information sent by capture process SE (step 510). Analyzer process SA checks the combination of application name, product name and message (which could be an error message) in knowledge base map KM (step 520). If this combination does not exist in knowledge base KB, analyzer process SA will add a new entry into knowledge base map KM (step 530). Analyzer process SA will then start a chat session and send all the information it received from capture process SE to chat server CS on behalf of the user (step 540), so that the user need not explain the application context to an analyst. Analyzer process SA relies on chat server CS to route the chat session to a particular analyst. This may be implemented by analyzer process SA using a URL-based interface to chat server CS, or by other means, such as an API. The URL may be specified in a configuration file.

If the combination exists in the database, then analyzer process SA will check whether the message is mapped to any knowledge base document (step 560). If the message is not mapped to any knowledge base document, Analyzer process SA starts a chat session as described for the earlier case (step 540).

If the message is mapped to a knowledge base document, then analyzer process SA will retrieve the corresponding document from knowledge base KB and send the same to the user (step 570). This may be implemented by the analyzer process SA using a URL-based interface to the knowledge base system, or by other means, such as an API. The URL may be specified in a configuration file.

Even after reading the knowledge base document, if the user is not satisfied with the information, or the problem is not solved (step 580), the user can click a link on the help page provided by analyzer process SA. Analyzer process SA then starts a chat session and sends the context information to the support analyst for further help (step 540) and may also send the retrieved knowledge base document to the support analyst. The user can give feedback on the document provided by Analyzer process SA. This feedback can be used for revising and updating the knowledge base documents.

Knowledge base map KM can be updated using an application that allows an administrator to map unmapped documents to documents in knowledge base KB, or to remap documents that have already been mapped. This application may use a URL-based search interface to the knowledge base system to present choices of documents, related to the context information being mapped, to the administrator, who can then select the document to be used for the mapping.

Further embodiments of context information functionality and the online support forum are illustrated in the above-mentioned Provisional Application, incorporated by reference, for example at pages 52-76.

Several embodiments of the invention are specifically illustrated and/or described herein. However, it will be appreciated that modifications and variations of the invention are covered by the above teachings and within the purview of the appended claims without departing from the spirit and intended scope of the invention.

What is claimed is:

1. A method for providing help services, comprising:
receiving context information corresponding to an operating environment of a user application, the context information captured from the operating system running the application;
searching a knowledge base for help information relating to the context information; and
forwarding the context information to live support in an electronic forum, in the event no related help information is located.

2. The method of claim 1, wherein the context information is captured using an operating system hook.

3. The method of claim 1, wherein the electronic forum is one of a chat session and instant messaging.

4. The method of claim 1, wherein the context information includes at least one of application name, caption, application message, product name, product version, file version, language, user name, computer name, domain, and IP address.

5. The method of claim 1, further comprising:
adding the context information into the knowledge base, in the event no related help information is located.

6. The method of claim 1, further comprising:
transmitting to the user related help information located in the knowledge base.

7. The method of claim 6, further comprising:
receiving an indication from the user that a problem has not been solved; and
forwarding the context information to live support in the electronic forum.

8. The method of claim 7, further comprising:
forwarding the related help information to live support in the electronic forum

9. A system for providing help services, comprising:
a processor; and
a memory, coupled to the processor, storing instructions adapted to be executed by the processor to:
receive context information corresponding to an operating environment of a user application, the context information captured from the operating system running the application;
search a knowledge base for help information relating to the context information; and
forward the context information to live support in an electronic forum, in the event no related help information is located.

10. The system of claim 9, wherein the context information is captured using an operating system hook.

11. The system of claim 9, wherein the electronic forum is one of a chat session and instant messaging.

12. The system of claim 9, wherein the context information includes at least one of application name, caption, application message, product name, product version, file version, language, user name, computer name, domain, and IP address.

13. The system of claim 9, wherein the instructions are further adapted to add the context information into the knowledge base, in the event no related help information is located.

14. The system of claim 9, wherein the instructions are further adapted to transmit to the user related help information located in the knowledge base.

15. The system of claim 14, wherein the instructions are further adapted to receive an indication from the user that a problem has not been solved and forward the context information to live support in the electronic forum.

16. The system of claim 15, wherein the instructions are further adapted to forward the related help information to live support in the electronic forum

17. A system for providing help services, comprising:
means for receiving context information corresponding to an operating environment of a user application;
means for searching a knowledge base for help information relating to the context information; and
means for forwarding the context information to live support in an electronic forum, in the event no related help information is located.
